(19) United States
(12) Patent Application Publication
(10) Pub. No.: US 2025/0040514 A1
(43) Pub. Date: Feb. 6, 2025

(54) Separable Dog Toy

(71) Applicant: Crazy Dog T-Shirts, Inc., Rochester, NY (US)

(72) Inventor: Bill Kingston, Rochester, NY (US)

(73) Assignee: Crazy Dog T-Shirts, Inc., Rochester, NY (US)

(21) Appl. No.: 18/362,403

(22) Filed: Jul. 31, 2023

(51) Int. Cl. A01K 15/02

(52) U.S. Cl. CPC A01K 15/025

(57) ABSTRACT

The separable dog toy has at least two components which are separable or partially separable from each other. The segments may be completely separable, or the segments may be in some way tethered together such that when the segments are separated from each other they remain connected by a connecting element. The separable segments have coupling features which enable the segments to be coupled to each other. The segments may have cavities into which the user may insert dog treats or mini-toys for the dog to find while playing with the toy. After the dog has removed and eaten the treats the owner may insert new treats into the cavities so that the dog may extract them again. This method of use is intended to keep the dog interested and engaged with the toy leading to increased stimulation and enjoyment for the dog.

### BACKGROUND

### Field of the Invention

This invention relates to toys; more particularly, to dog toys made from multiple parts which may be partially or wholly separable.

### Description of the Related Art

Pet owners are constantly seeking ways to provide their pets with toys that stimulate their curiosity and provide engagement for the dog. Some types of dog toys have gained significant popularity due to their chewable texture, colorful appearance, and for the comfort they provide to dogs during playtime and rest. However, conventional dog toys often lack features that address the unique proclivities of dogs, such as the interactivity of elements of the dog toys and adaptability to various play styles.

However, a significant limitation of these toys is their susceptibility to being easily chewed up and destroyed by dogs during play. By nature dogs possess a natural instinct to chew. Whether motivated by teething, anxiety, or sheer playfulness, dogs often engage in vigorous chewing activities that can quickly render conventional toys ineffective and unsafe. The destruction of toys not only poses a potential health hazard to dogs, with the risk of ingesting small parts or toxic materials, but it also results in recurring expenses for pet owners who constantly need to replace damaged toys. This issue has been a persistent concern for pet owners and manufacturers alike.

Another challenge faced by pet owners is the issue of dogs quickly losing interest in their toys. Despite the wide variety of toys available in the market, many dogs exhibit a pattern of becoming bored or disinterested with their toys after only a short period of play. This lack of sustained engagement poses a challenge for pet owners seeking to provide continuous mental and physical stimulation for their canine companions.

Dogs are intelligent and curious creatures, constantly seeking novelty and stimulation. However, conventional dog toys often lack the necessary features to maintain a dog's interest over time. Many toys have a limited range of interactive elements, resulting in predictable and repetitive play experiences. Once a dog becomes familiar with a toy's functionality or exhausts its limited capabilities, the toy loses its appeal and fails to captivate the dog's attention.

### SUMMARY

The disclosure concerns a unique design for a dog toy having multiple parts or components. The invention aims to provide an interactive and engaging experience for dogs by incorporating components that can be inserted and removed from each other and/or components that can be attached and detached from each other. Some of the dog toy components have cavities. Some of the cavities are only accessible to the dog as the toy is separated. The pet owner can place treats or mini-toys inside the cavities such that the dog is rewarded for playing with and/or pulling apart the toy. The treats or mini-toys offer an element of surprise for the dog, and they encourage dogs to explore and interact with the toy more extensively.

### General Description

The subject of this disclosure is herein referred to as a “dog toy” a “separable dog toy” or “the toy” interchangeably. The separable toy has at least two components or parts. The components may be partially or completely separable from each other. When the two or more components of the toy can be coupled together, the couplable parts are referred to as segments. When one or more of the toy components can be inserted into the cavity of one or more other toy components, the inserted components are referred to as mini-toys. Each segment may be completely separable, or the segments may be in some way tethered together such that when the segments are separated from each other they remain connected by a connecting element.

### Coupling Features

The separable segments have coupling features which are accessible from the exterior of the segments. The coupling features of one segment may be coupled to the coupling features of another segment. The coupling features allow the segments to be repeatably and reversibly coupled and decoupled to each other. In various embodiments, the coupling features may be made from a variety of materials and they may employ a variety of coupling mechanism types.

### Cavities

The segments or main body of the toy may have cavities. The cavities are pockets disposed within the interior volume of a given segment or main body. Dog treats or mini-toys may be inserted into the cavities of segments or main body. Each cavity has at least one opening into which the dog owner may insert treats or mini-toys. As the dog plays with the toy, the dog may extract the treats or mini-toys out of the cavity through a cavity opening. After the dog has removed and eaten the treats or removed the mini-toys, the owner may insert new treats or reinsert the mini-toys into the cavities so that the dog may extract them again. This method of use is intended to keep the dog interested and engaged with the toy leading to increased stimulation and enjoyment for the dog.

### Hidden Cavities

In some embodiments, the cavity openings can be located in an area on a surface of a segment which is covered when the segment is coupled with another segment. To elaborate, when a set of segments are coupled together there can be a surface on a first segment which is pressed up against the surface on a secondary segment. If the cavity opening is located in the area which is pressed up against another segment, the dog will have to pull the segments apart before they gain access to the opening. This adds another layer of engagement for the dog by promoting a kind of problem-solving skill, leading to further enjoyment of the toy.

### Invention Summary

In some embodiments, the dog toy has separable segments which may be coupled together. The segments may be completely separable or they may be partially separable. The components of partially separable embodiments may remain tethered together by a connecting element. Each segment has coupling features which may be coupled to the coupling features of other segments. Some segments may have cavities. The opening to some cavities may be strategically located such that the opening is hidden when two or more segments are coupled together.

The invention is primarily directed towards use by dogs, but it should not be thought of strictly applying to dogs. For example, the separable toy could be used by other animals/users such as cats, ferrets, or human children. The general structure and component part functions of the separable toy would remain the same, but the size of the toy and the coupling feature mechanisms may vary between different embodiments depending, in-part, on the intended application of the toy.

### BRIEF DESCRIPTION OF THE DRAWINGS

Other features, combinations, and embodiments will be appreciated by one having the ordinary level of skill in the art of toys and accessories upon a thorough review of the following details and descriptions, particularly when reviewed in conjunction with the drawings, wherein:

FIG. 1 shows a front view of a pet toy in accordance with a first illustrated embodiment;

FIG. 2 shows a back view of the pet toy in accordance with a first illustrated embodiment;

FIG. 3 shows an exploded front view of the pet toy in accordance with a first illustrated embodiment;

FIG. 4 shows a front view of the pet toy in accordance with a second illustrated embodiment;

FIG. 5 shows a back view of the pet toy in accordance with a second illustrated embodiment;

FIG. 6 shows an exploded front view of the pet toy in accordance with a second illustrated embodiment;

FIG. 7 shows a front view of the pet toy in accordance with a third illustrated embodiment;

FIG. 8 shows a back view of the pet toy in accordance with a third illustrated embodiment;

FIG. 9 shows an exploded view of the pet toy in accordance with a third illustrated embodiment;

FIG. 10 shows a front view of the pet toy in accordance with a fourth illustrated embodiment;

FIG. 11 shows a front view of the pet toy in accordance with a fourth illustrated embodiment;

FIG. 12 shows an exploded view of the pet toy in accordance with a fourth illustrated embodiment;

FIG. 13 shows a front view of the pet toy in accordance with a fifth illustrated embodiment;

FIG. 14 shows a front view of the pet toy in accordance with a fifth illustrated embodiment;

FIG. 15 shows an exploded view of the pet toy in accordance with a fifth illustrated embodiment;

FIG. 16 shows an exploded view of the pet toy in accordance with a sixth illustrated embodiment;

FIG. 17 shows an exploded view of the pet toy in accordance with a seventh illustrated embodiment;

FIG. 18 shows a detail view of a version of a coupling feature;

FIG. 19 shows a detail view of a version of a coupling feature;

FIG. 20 shows a detail view of a type of an article of Velcro that may be used as a coupling feature;

FIG. 21 shows a detail view of a type of an article of Velcro that may be used as a coupling feature;

FIG. 22 shows a detail view of a type of an article of Velcro that may be used as a coupling feature;

FIG. 23 shows a front view of the pet toy in accordance with an eighth illustrated embodiment; and

FIG. 24 shows a front view of the pet toy in accordance with an eighth illustrated embodiment.

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

For purposes herein, the terms “pet toy,” “dog toy,” “the toy,” and “separable toy” are used interchangeably and they all refer to the present invention.

The term “coupling feature” refers to the mechanism which reversibly couples two or more segments together.

The term “Velcro” or “article of Velcro” refer to a coupling feature or a system of features. There are a variety of Velcro types, for example and without limitation, “hook-and-loop,” “high-technology hooks,” and “mushroom hook” Velcro types.

The term “cavity” refers to a hole or void space which is disposed within the dog toy, and into which dog treats or mini-toys may be inserted.

The term “textile,” “textiles,” and “textile material” refers to a group of materials which includes various fiber-based materials, including fibers, yarns, filaments, threads, different fabric types; not limited to woven fabrics alone.

Unless explicitly defined herein, terms are to be construed in accordance with the plain and ordinary meaning as would be appreciated by one having skill in the art.

### GENERAL DESCRIPTION OF EMBODIMENTS

The separable toy may take a wide variety of forms.

### First Segment

In some embodiments, the separable toy has a first segment. The first segment has a volume and an exterior surface which largely encloses the first segment volume. The first segment has one or more first coupling features disposed on the first segment exterior surface.

### Secondary Segment

In some embodiments, the separable toy has at least one secondary segment. Each secondary segment has a volume and an exterior surface which largely encloses the secondary segment volume. Each secondary segment has one or more coupling features disposed on the first segment exterior surface. These secondary segment coupling features are configured to reversibly couple with the first segment coupling features.

### Cavities

In some embodiments, the first segment, secondary segments, or main body of the toy have cavities disposed within them. In some embodiments, the first segment may lack a cavity. Each cavity may have a plurality of cavity openings. Cavity openings are holes or penetrations which lead into the interior of the cavity. The cavity openings may pass through the exterior surface of the first segment, the secondary segments, or the main body of the toy. The cavity openings may be disposed on the exterior of the first segment, secondary segment, or main body such that a dog may access the cavity opening.

The user may insert dog treats, mini-toys, or other objects of interest for the dog into the cavity. After treats or mini-toys are inserted into the cavity and the dog toy is given to the dog, the dog may then begin extracting the treat or mini-toy from the cavity.

### Tertiary Segments

In some embodiments, the dog toy may have one or more tertiary segments which may lack cavities. Similar to first segments and secondary segments, the tertiary segments may have coupling features such that they may be coupled and decoupled from first segments and secondary segments. However, tertiary segments do not have cavities.

### Cavity Location

In some embodiments, the cavity openings may be located on the first segment or secondary segments such that the dog may readily access the cavity openings when the first segment is coupled to the secondary segment or segments. In some embodiments, the cavity openings may be located on the secondary segments such that the dog may not readily access the cavity openings when the first segment is coupled to the secondary segment or segments.

In some embodiments, the cavity openings may not readily accessible to the dog because the first coupling feature or secondary coupling feature are near the cavity opening. In some embodiments, the cavity openings are not readily accessible to the dog because the first coupling feature or secondary coupling feature are disposed around the cavity opening. The first coupling feature or secondary coupling feature may surround the cavity opening. For example, a coupling feature may form a pattern which encircles the cavity opening. In some embodiments, the coupling feature may be formed from separate patches which are nevertheless arranged around the cavity opening such that when the coupling feature is coupled to another coupling feature the cavity opening is covered, and not readily accessible to the dog.

The first coupling feature or secondary coupling feature may only partially surround the cavity opening. A coupling feature may be made from multiple individual coupling feature sub-components. For example, a coupling feature may be formed from a single, continuous Velcro patch. Alternatively, a coupling feature may be formed from multiple Velcro patches.

### Velcro Coupling Features

In some embodiments, the coupling features may be formed from Velcro patches. A Velcro patch or an adjacent set of Velcro patches which form a coupling feature are collectively referred to herein as an “article of Velcro.” There are a wide variety of Velcro types which may be used in the coupling feature application. The embodiments utilizing articles of Velcro for the coupling features may make use of any existing type of Velcro or future, yet to be made available, types of Velcro. For example, and without limitation, the coupling features may utilize “hook-and-loop,” “high-technology hooks,” and “mushroom hook” Velcro types.

An article of Velcro may be attached to the first, secondary, or tertiary segments by sewing or otherwise adhering it.

### Ball-and-Socket Coupling Features

The coupling features may be formed by a variety of other structures or mechanisms besides articles of Velcro. In some embodiments, coupling features may form a “ball-and-socket” relationship wherein one coupling feature forms a generally rounded “ball” shape, referred to herein as “the ball,” and the second coupling feature forms a generally concave “socket” shape, referred to herein as “the socket,” into which the ball may be inserted. In some embodiments, the socket, the ball, or both the socket and the ball, may be made of a flexible material such that the coupled ball and socket form a snap-fit coupling. In the snap-fit style of ball-and-socket coupling the user may press the ball against the socket, progressively deforming the socket until such a point where ball snaps into the socket. After the ball has been inserted into the socket, the socket retains the ball until adequate pulling force is applied to the ball such that the socket deforms enough that the ball may be removed.

In some embodiments, a coupling feature on the first segment forms the ball and the coupling features on the secondary segment or tertiary segment forms the socket. In some embodiments, the cavity opening may be disposed within the socket such that only after the ball is separated from the socket is the cavity opening readily accessible to the dog.

### Sleeve-and-Insert Coupling Features

In some embodiments, coupling features may form a “sleeve-and-insert” relationship wherein one coupling feature forms a generally hollow receiving shape, referred to herein as “the sleeve,” and the other coupling feature forms a shape which may be inserted into the sleeve, referred to herein as the insert. The insert may be retained within the sleeve by friction alone. In some embodiments, inserts retained within the sleeve by friction alone may form interference fit within the sleeve. In some embodiments, one or more protrusions may be disposed on the insert which match with detents disposed on the interior of the sleeve. In some embodiments, the sleeve, the insert, or both the sleeve and insert may be made from a flexible material such that the coupled sleeve and insert forms a snap-fit coupling. In the snap-fit style of sleeve-and-insert coupling the user may press the insert into the socket, progressively deforming the sleeve until such a point where insert snaps into the sleeve. After the insert has been inserted into the sleeve, the sleeve retains the insert until adequate pulling force is applied to the insert such that the socket deforms enough that the sleeve may be removed.

In some embodiments, a coupling feature on the first segment forms the sleeve and a coupling feature on the secondary segment or tertiary segment forms the insert. In some embodiments, a coupling feature on the first segment forms the insert and a coupling feature on the secondary segment or tertiary segment forms the sleeve. In some embodiments, the cavity opening may be disposed within the sleeve such that only after the insert is separated from the socket is the cavity opening readily accessible to the dog. In some embodiments, the cavity opening may be disposed within the insert such that only after the insert is separated from the socket is the cavity opening readily accessible to the dog.

### Construction Material Options

The toy may be made from a variety of materials. For example and without limitation, the dog toy may be made primarily from textiles and stuffing, from rubber materials, from plastic materials, or some combination thereof. In embodiments where the dog toy is made from textiles and stuffing the exterior surface of the dog toy is formed from one or more textile material panels. The textile panels may be attached to one another by sewing them together or by other suitable means. The stuffing material used is a light, soft, and voluminous material, for example polyester fiberfill, synthetic fiber, batting, cotton, straw, wood wool. In some embodiments, the dog toy exterior surface and the cavities are all made from textile material.

In some embodiments, the toy segments or main body may be made from multiple materials in combination. In some embodiments, the cavity and cavity opening may be made from the same material as the exterior surface of the first segment, the exterior surface of the secondary segment the exterior surface of the tertiary segment, or the exterior surface of the main body. For example, the exterior surface may be textile material and the cavity and cavity opening may be a textile material.

In some embodiments, the material of the cavity and the cavity opening may differ from the material of a toy exterior surface. For example, the segment may be textile material and the cavity may be made from plastic or rubber. In still other embodiments the cavity, the cavity opening, and the exterior surface of the segment the cavity is disposed within may be made from a single continuous material. For example, the cavity may be formed during the same injection molding process that forms and shapes the exterior surface of a given segment.

In some embodiments, the toy segments or main body may incorporate supporting materials. Supporting materials may be applied and integrated into the toy to enhance the structural quality of the toy. For example, supporting materials may be integrated around the cavity opening such that the cavity opening is better supported. In some embodiments, the supporting material may be attached to the segment or main body, and the cavity opening may be attached to the supporting material. The supporting material may be formed from textile materials, plastic materials, rubber materials, or other suitably durable, supporting materials.

### Connecting Element

In some embodiments, the segments may be joined together by an intermediate connecting element. The connecting element may have at least a first end and a second end. The first end may be coupled or attached to a segment, and the second end may be coupled or attached to a separate segment. The connecting element may serve as a tether between two or more segments, preventing them from fully detaching from each other even after the coupling features of two or more segments have been decoupled from each other.

In some embodiments, the connecting element is coupled or attached between segments such that when the segments are coupled together the connecting element may be enveloped by the segments. The connecting element may be hidden from view when the segments are coupled together.

### Manufacturing

Each of the components of the Separable Dog Toy and related system described herein may be manufactured and/or assembled in accordance with the conventional knowledge and level of a person having skill in the art.

While various details, features, combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

### First Illustrated Embodiment

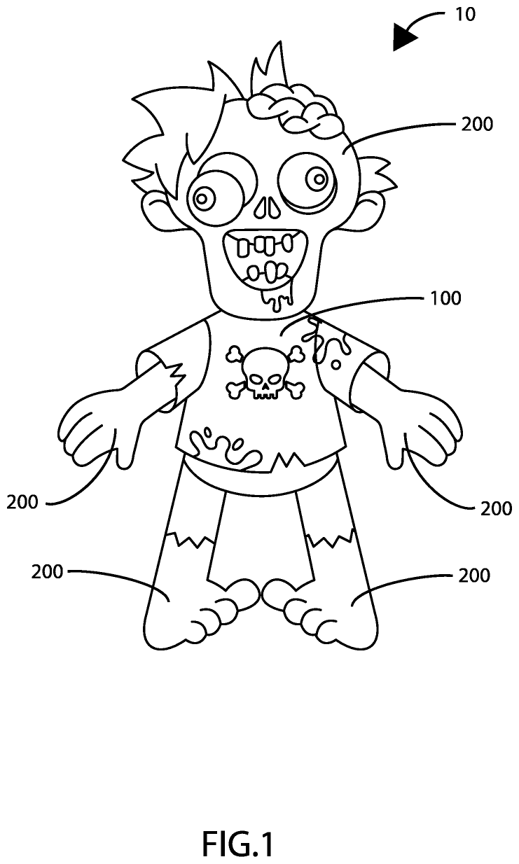

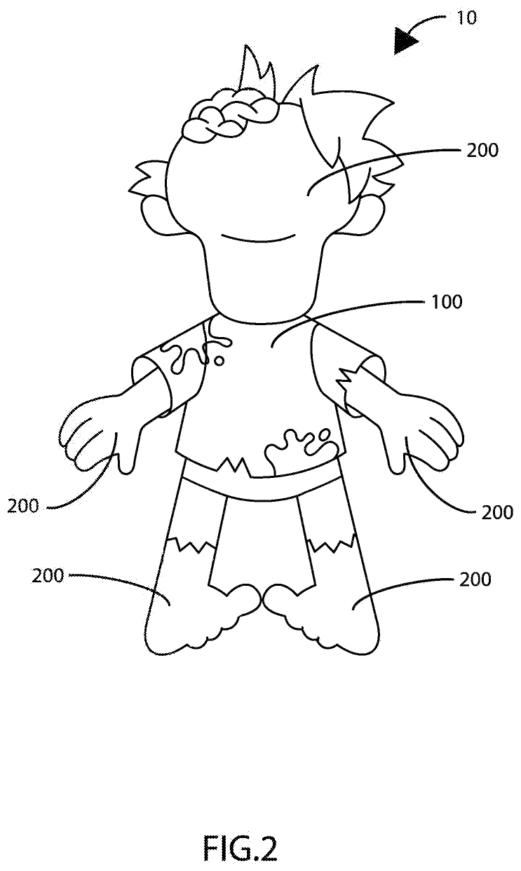

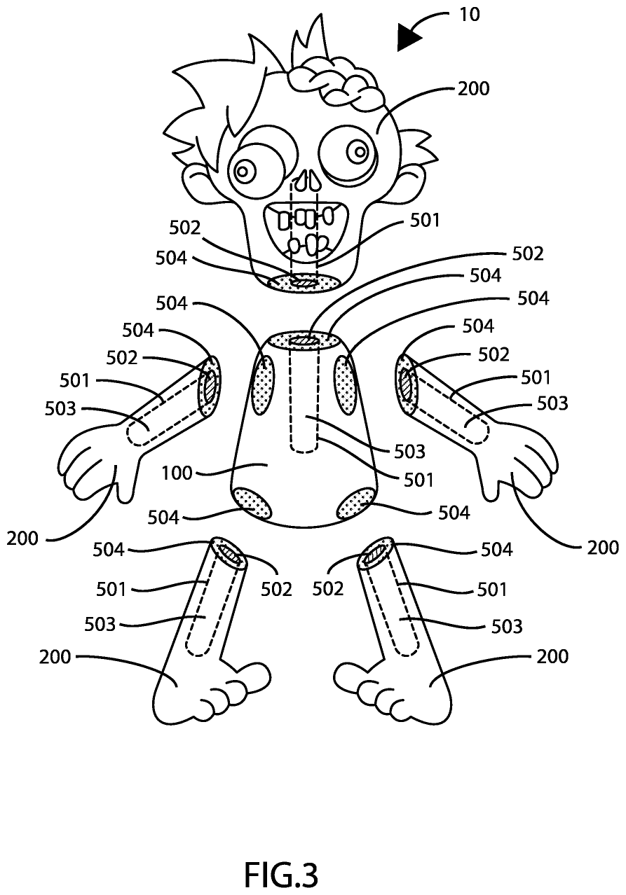

A first illustrated embodiment of the toy (10) is shown in FIG. 1-FIG. 3. The first illustrated embodiment has a first segment (100) and five secondary segments (200). The first segment has a cavity (501) having a cavity volume (503) and a cavity opening (502). Each of the secondary segments has a cavity having a cavity volume and a cavity opening. The first segment has a first segment exterior (101) forming the outer surface of the first segment. The secondary segments each have a secondary segment exterior (201) forming the outer surface of the secondary segment. Coupling features (504) are disposed on the first segment exterior and the secondary segment exterior such that the coupling feature of the first segment may be coupled with the coupling feature of the secondary segment. The coupling features in the first illustrated embodiment are articles of Velcro (506), represented by the stippled or dotted hatch pattern. In other versions of the first illustrated embodiment other coupling features may be used.

### Second Illustrated Embodiment

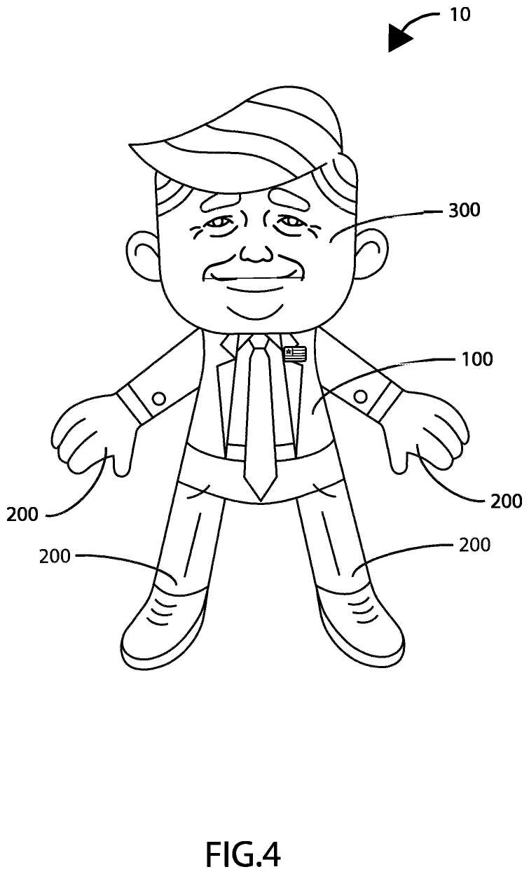

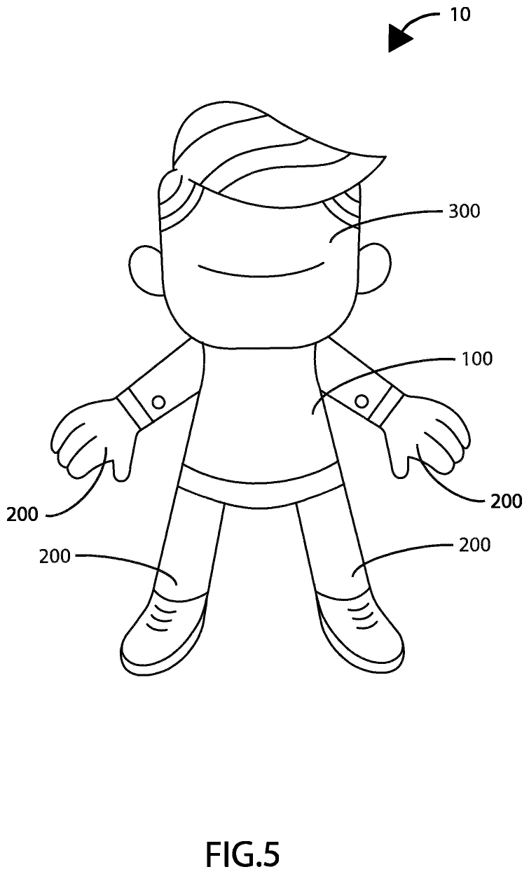

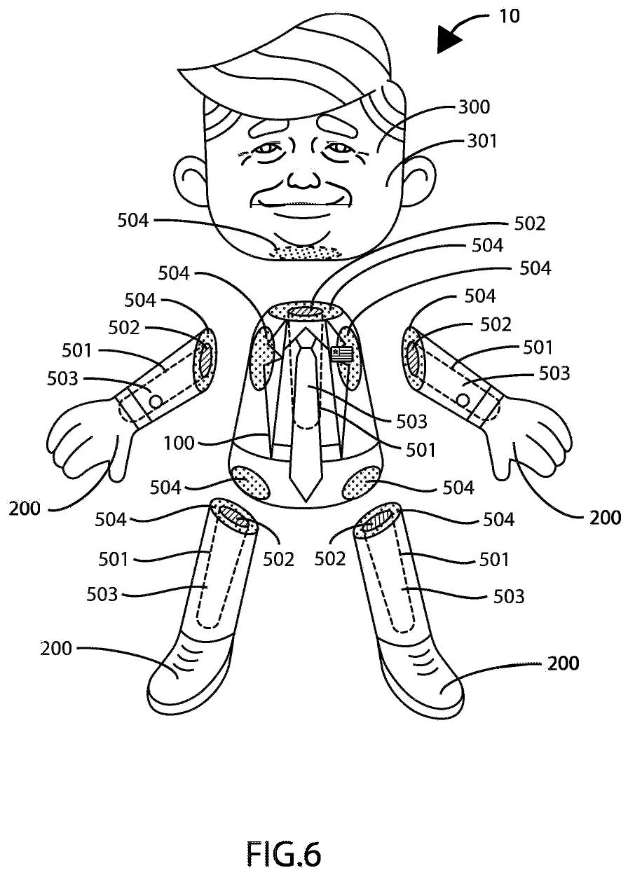

A second illustrated embodiment of the toy (10) is shown in FIG. 4-FIG. 6. The second illustrated embodiment has a first segment (100), four secondary segments (200), and one tertiary segment (300). The first segment has a cavity (501) having a cavity volume (503) and a cavity opening (502). Each of the secondary segments has a cavity having a cavity volume and a cavity opening. The first segment has a first segment exterior (101) forming the outer surface of the first segment. Each of the secondary segments have a secondary segment exterior (201) forming the outer surface of the secondary segment. The tertiary segment has a tertiary segment exterior (301) forming the outer surface of the tertiary segment. Coupling features (504) are disposed on the first segment exterior and the secondary segment exterior such that the coupling feature of the first segment may be coupled with the coupling feature of the secondary segment. Similarly, coupling features are disposed on the first segment exterior and the tertiary segment exterior such that the coupling feature of the first segment may be coupled with the coupling feature of the tertiary segment. The coupling features in the second illustrated embodiment are articles of Velcro (506), represented by the stippled or dotted hatch pattern. In other versions of the second illustrated embodiment other coupling features may be used.

### Third Illustrated Embodiment

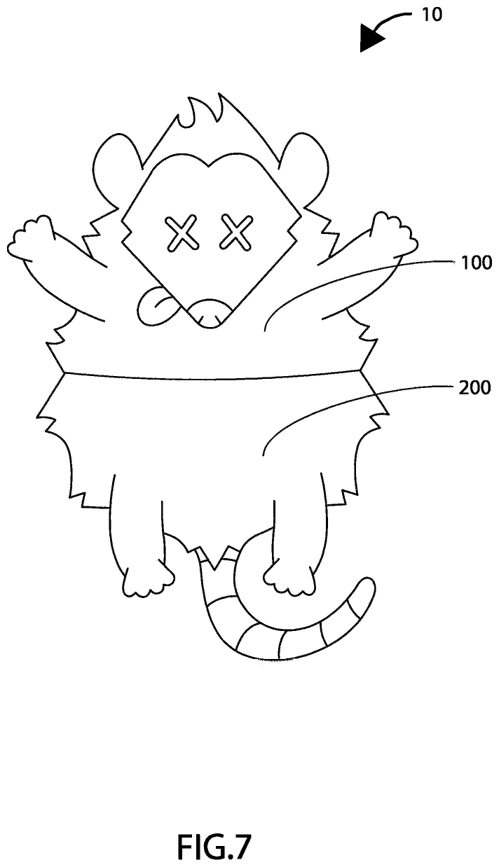

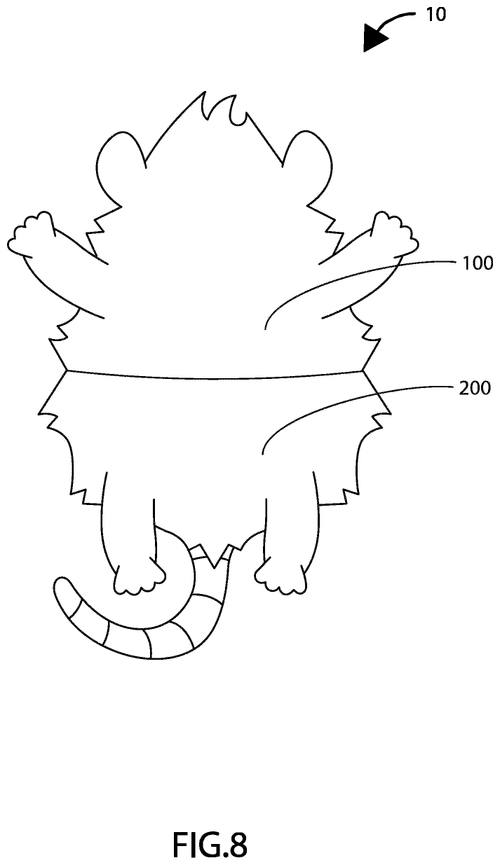

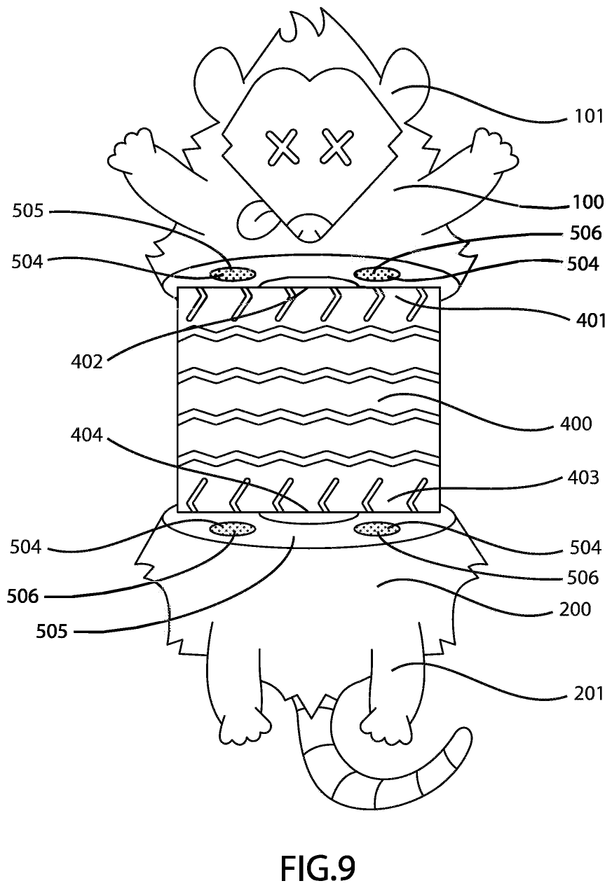

A third illustrated embodiment of the toy (10) is shown in FIG. 7-FIG. 9. The third illustrated embodiment has a first segment (100) and a secondary segment (200). The third illustrated embodiment as shown in FIG. 9 has a mating surface (505) disposed the first segment and a mating surface disposed on the secondary segment. There is a connecting element (400) attached between the first segment and the secondary segment. The connecting element first end (401) is attached to the mating surface of the first segment. The point of their attachment is labeled the first end attachment point (402). The connecting element second end (403) is attached to the mating surface of the secondary segment. The point of their attachment is labeled the second end attachment point (404). Neither the first segment nor the secondary segment of the third illustrated embodiment have cavities. However, a different version of the third illustrated embodiment could have a plurality of cavities disposed on a first segment exterior (101), on a secondary segment exterior, on a mating surface, or some combination thereof. Coupling features (504) are disposed on the first segment exterior and the secondary segment exterior such that the coupling feature of the first segment may be coupled with the coupling features of the secondary segment. The coupling features in the third illustrated embodiment are articles of Velcro (506), represented by the stippled or dotted hatch pattern. In other versions of the third illustrated embodiment other coupling features may be used.

### Fourth Illustrated Embodiment

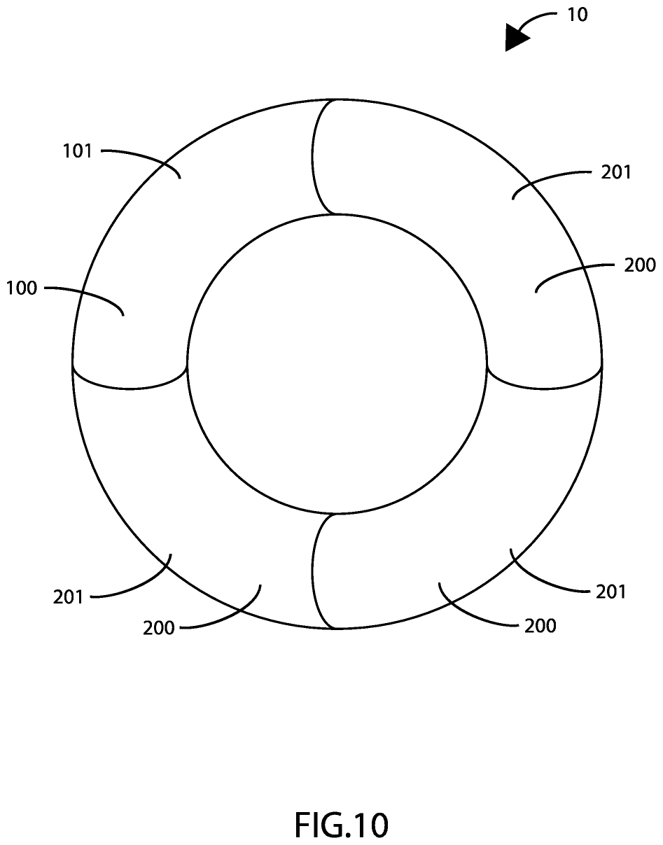

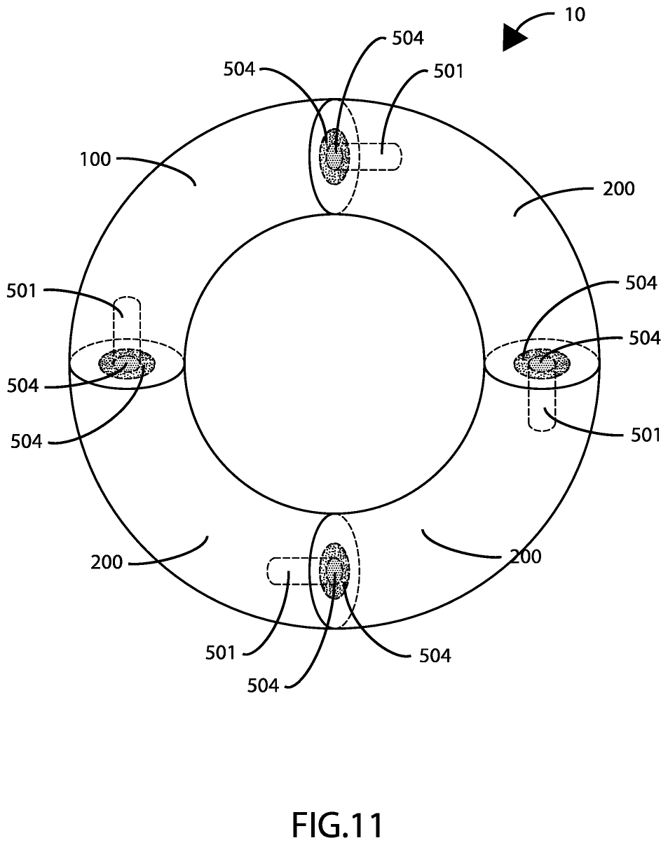

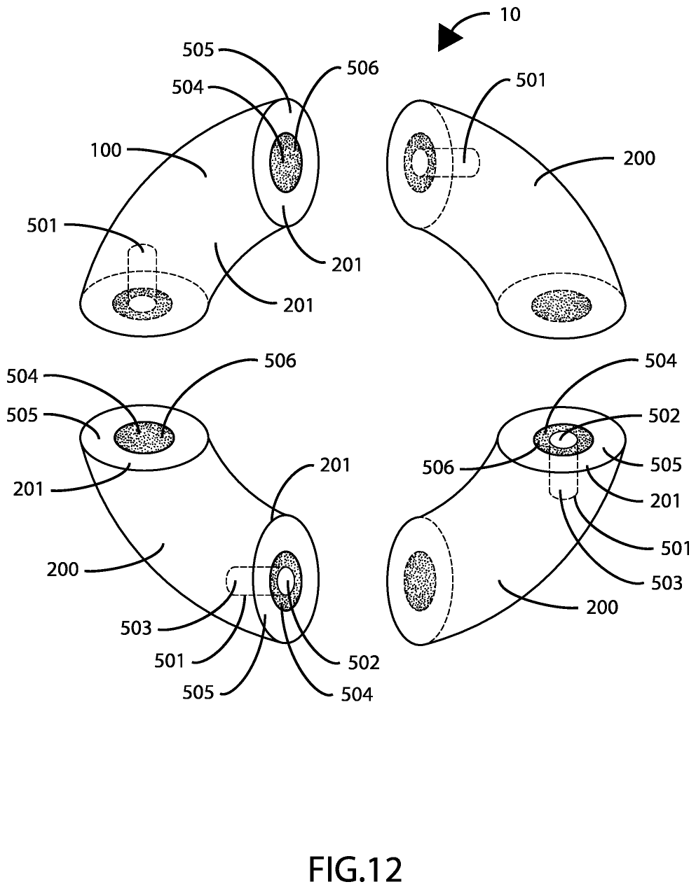

A fourth illustrated embodiment of the toy (10) is shown in FIG. 10-FIG. 12. The fourth illustrated embodiment has a first segment (100) and three secondary segments (200). Each segment of the fourth illustrated embodiment has a mating surface (505). Each segment of the fourth illustrated embodiment has the same features of the other three segments, showing that a segment identified as a first segment need not differ from a segment identified as a secondary segment. In the fourth illustrated embodiment each segment has two mating surfaces, a cavity (501), and two coupling features (504).

### Fifth Illustrated Embodiment

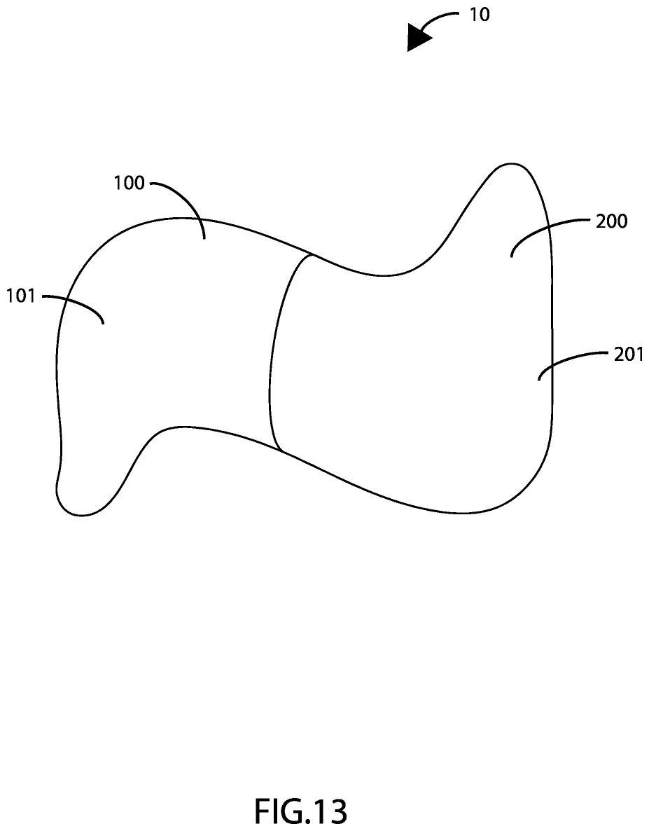

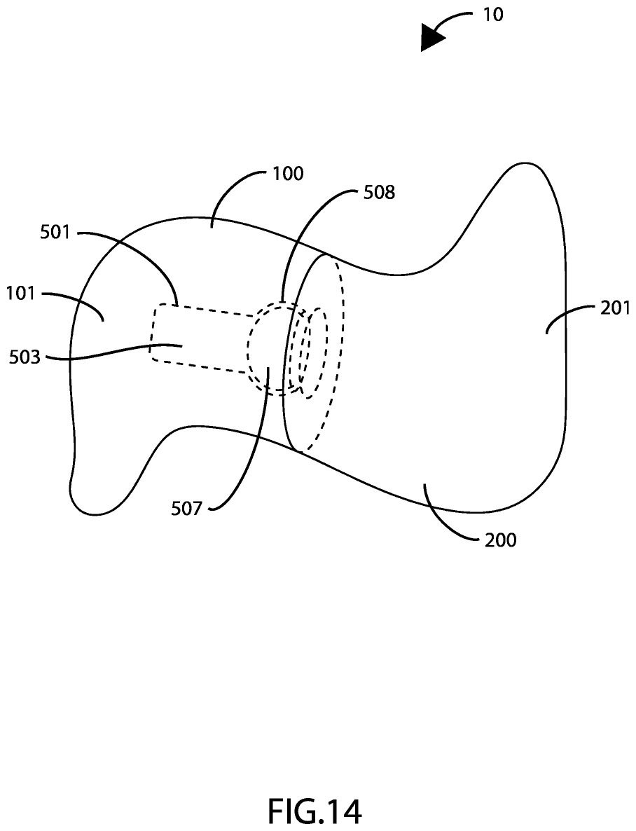

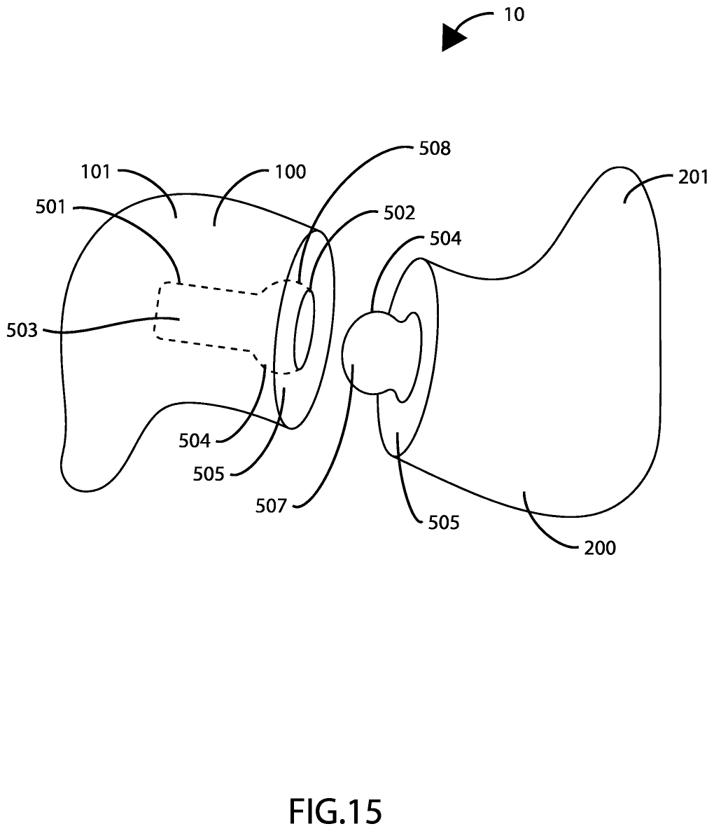

A fifth illustrated embodiment of the toy (10) is shown in FIG. 13-FIG. 15. The fifth illustrated embodiment has a first segment (100) and a secondary segment (200). Each segment has a coupling feature (504). The coupling feature of the fifth illustrated embodiment form a ball-and-socket relationship. The first segment has a cavity (501) and cavity opening (502). Between the cavity and the cavity opening there is a socket (508). The socket is the coupling feature for the first segment. The secondary segment has a ball (507). The ball is the coupling feature for the secondary segment. To couple the first segment to the secondary segment the ball is inserted into the socket. In other versions of the fifth illustrated embodiment the coupling features may be reversed. The ball coupling feature may be on the first segment. The cavity and socket coupling feature may be on the secondary segment. The primary purpose of including the fifth illustrated embodiment is to show a possible configuration of the ball-and-socket coupling feature system.

### Sixth Illustrated Embodiment

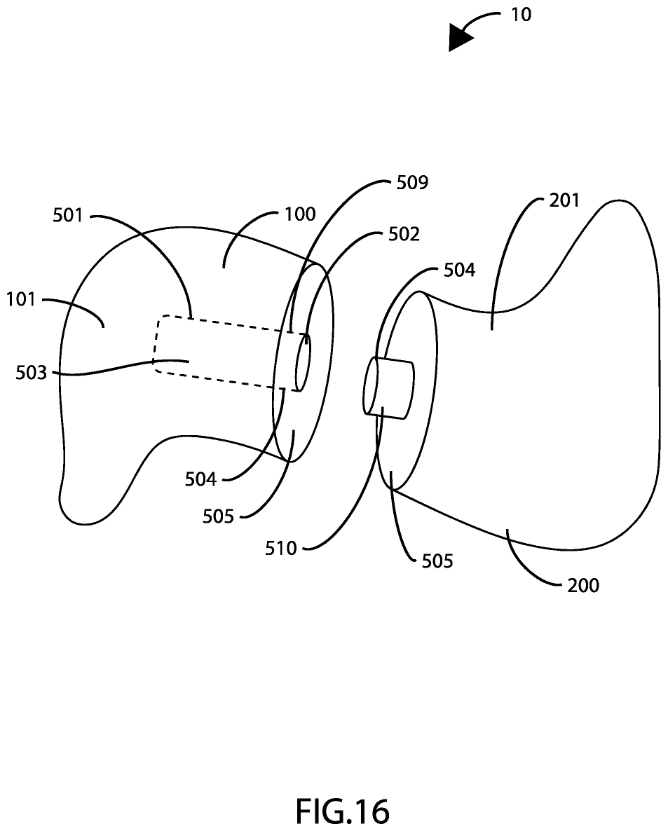

A sixth illustrated embodiment of the toy (10) is shown in FIG. 16. The sixth illustrated embodiment has a first segment (100) and a secondary segment (200). Each segment has a coupling feature (504). The coupling feature of the sixth illustrated embodiment form a sleeve-and-insert relationship. The first segment has a cavity (501) and cavity opening (502). Between the cavity and the cavity opening there is a sleeve (509). The sleeve is the coupling feature for the first segment. The secondary segment has an insert. The insert is the coupling feature for the secondary segment. To couple the first segment to the secondary segment the insert is inserted into the sleeve. In other versions of the sixth illustrated embodiment the coupling features may be reversed. The insert coupling feature may be on the first segment. The cavity and sleeve coupling feature may be on the secondary segment. The primary purpose of including the sixth illustrated embodiment is to show a possible configuration of the sleeve-and-insert coupling feature system.

### Seventh Illustrated Embodiment

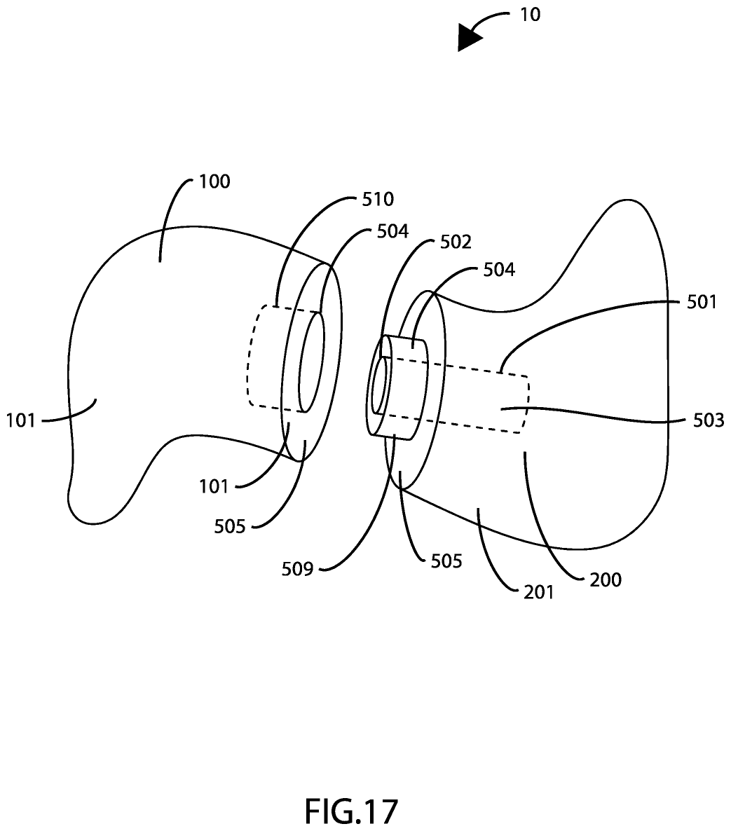

A seventh illustrated embodiment of the toy (10) is shown in FIG. 17. The sixth illustrated embodiment has a first segment (100) and a secondary segment (200). Each segment has a coupling feature (504). The coupling feature of the seventh illustrated embodiment form a sleeve-and-insert relationship. The secondary segment has a cavity (501) and cavity opening (502). Between the cavity and the cavity opening there is an insert (510). The insert is the coupling feature for the secondary segment. The first segment has a sleeve (509). The sleeve is the coupling feature for the first segment. To couple the first segment to the secondary segment the insert is inserted into the sleeve. In other versions of the seventh illustrated embodiment the coupling features may be reversed. The sleeve coupling feature may be on the secondary segment. The cavity and insert coupling feature may be on the first segment. The primary purpose of including the seventh illustrated embodiment is to show a possible configuration of the sleeve-and-insert coupling feature system.

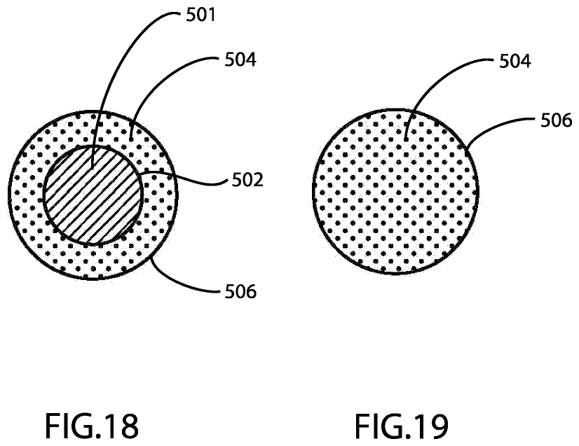

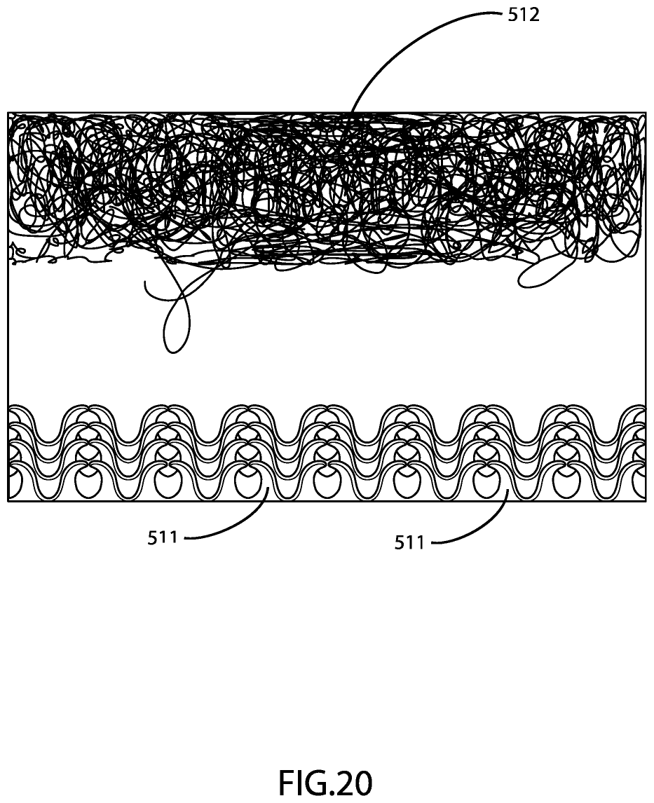

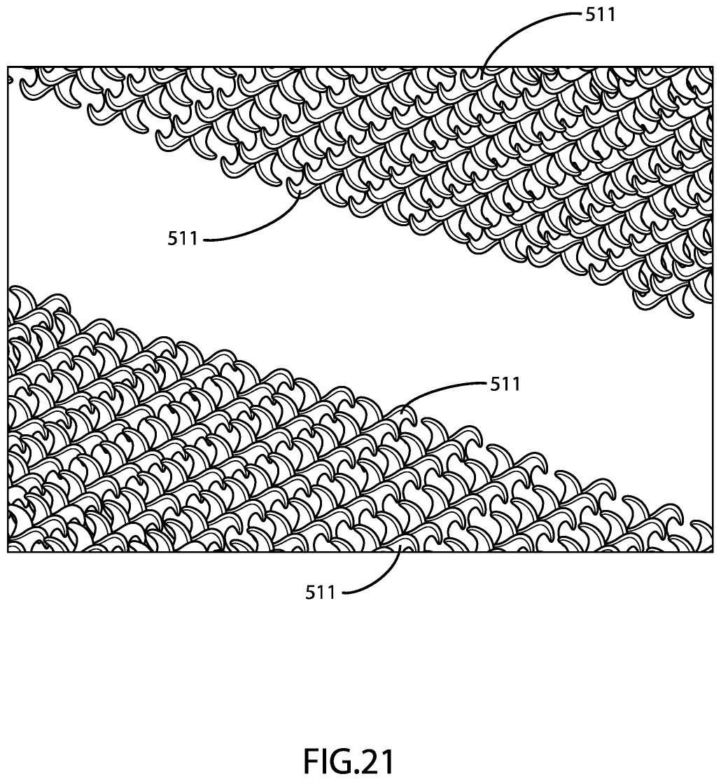

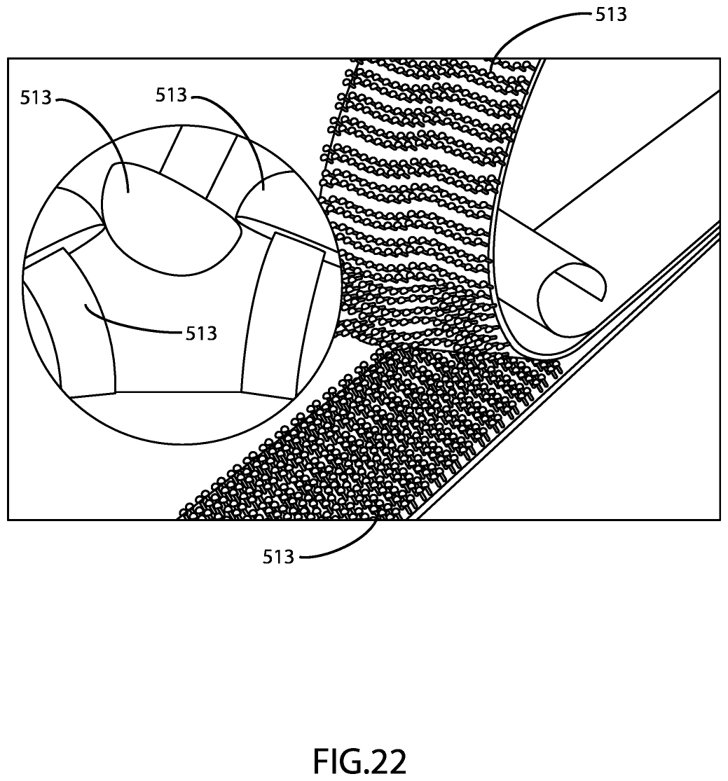

Various articles of Velcro (506) and coupling features (504) made from articles of Velcro are shown in FIG. 18-FIG. 22. A first type of Velcro called hook-and-loop Velcro is shown in FIG. 20. Hook-and-loop Velcro has one side of hooks (511) and an opposing side of loops (512). A second type of Velcro called high-technology hooks is shown in FIG. 21. High-technology hooks has two sides of arrayed hooks (511) which may be coupled together. A third type of Velcro called mushroom hook is shown in FIG. 22. Mushroom hook Velcro has two sides of arrayed mushroom shaped features, or mushrooms (513), which may be coupled together. These three types of Velcro do not limit the types of Velcro that may be used. Other kinds of equivalent Velcro types may be used as well.

### Eighth Illustrated Embodiment

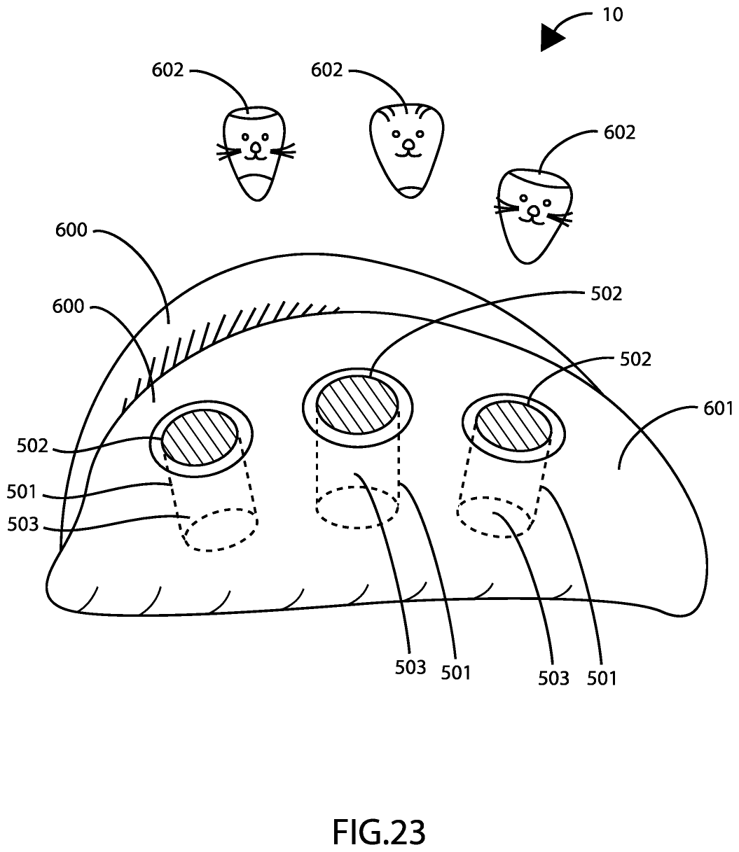

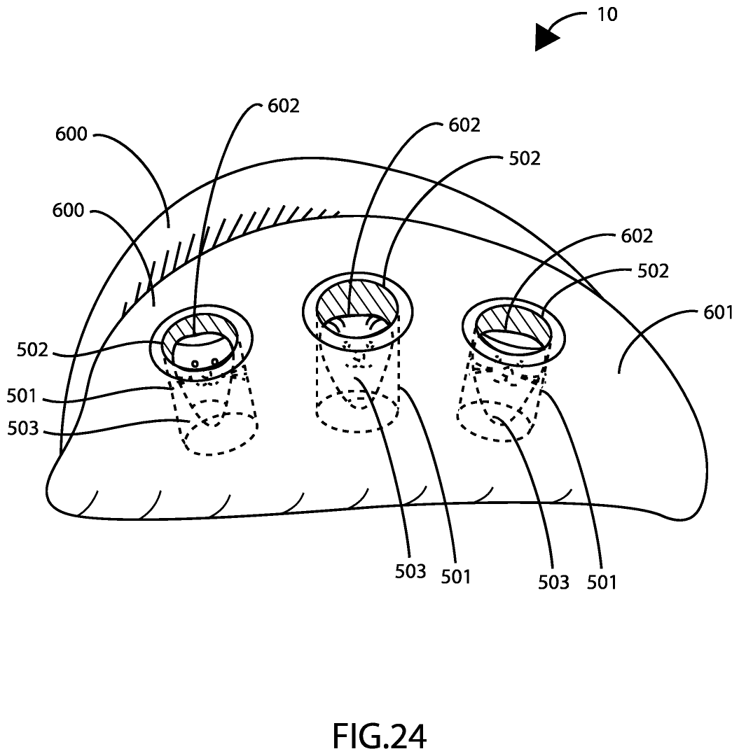

An eighth illustrated embodiment of the toy (10) is shown in FIG. 23 and FIG. 24. The eighth illustrated embodiment has a main body (600). The main body has a main body exterior (601) which surrounds the main body. The main body has three cavities (501), each cavity having a cavity opening (502) disposed on the main body exterior. Each cavity has a cavity volume which extends into the main body. This embodiment also has mini-toys (602) which may be inserted into the main body cavities. The mini-toys may be removed by the dog and reinserted by the user.

### FEATURE LIST

Toy (10)
First Segment (100)
First Segment Exterior (101)
Secondary Segment (200)
Secondary Segment Exterior (201)
Tertiary Segment (300)
Tertiary Segment Exterior (301)
Connecting Element (400)
Connecting Element First End (401)
First End Attachment Point (402)
Connecting Element Second End (403)
Second End Attachment Point (404)
Cavity (501)
Cavity Opening (502)
Cavity Volume (503)
Coupling Feature (504)
Mating Surface (505)
Article of Velcro (506)
Ball (507)
Socket (508)
Sleeve (509)
Insert (510)
Hooks (511)
Loops (512)
Mushrooms (513)
Main Body (600)
Main Body Exterior (601)
Mini-toy (602)

What is claimed is:

1. A pet toy, comprising:
a. A first segment having a volume, the first segment having a plurality of first coupling features disposed on the first segment exterior.
b. A plurality of secondary segments each having a volume, the secondary segments each having a plurality of secondary coupling features disposed on the secondary segment exterior, the secondary coupling features configured to reversibly couple with the first coupling features, the secondary segments having a plurality of secondary cavities disposed within the secondary segments, the secondary cavities each having a plurality of cavity openings and an interior cavity volume, the cavity openings being disposed on the secondary segment exterior.

2. The pet toy of claim 1, wherein:
a. A plurality of cavity openings on the secondary segment or segments are located such that when the secondary segments are coupled with the first segment, the cavity openings are covered by the first segment.

3. The pet toy of claim 1, further comprising:
a. A plurality of first cavities disposed within the first segment volume, the first cavities having a cavity opening and an interior cavity volume, the cavity opening being disposed on the secondary segment exterior.

4. The pet toy of claim 1 further comprising:
a. A plurality of tertiary segments, the tertiary segments having a plurality of tertiary coupling features configured to couple with the first coupling features.

5. The pet toy of claim 1 further comprising:
a. A plurality of tertiary segments, the tertiary segments having a plurality of tertiary coupling features configured to couple with the secondary coupling features.

6. The pet toy of claim 1, wherein:
a. The first coupling feature is an article of Velcro attached to the first segment, and the secondary coupling feature is an article of Velcro which is attached to the secondary segment.

7. The pet toy of claim 6, wherein:
a. The article of Velcro used for the first coupling feature is a continuous patch and the article of Velcro used for the secondary coupling feature is comprised of a plurality of patches which are disposed around the cavity opening.

8. The pet toy of claim 6, wherein:
a. The article of Velcro used for the secondary coupling feature forms a ring shape which encircles the cavity opening.

9. The pet toy of claim 1, wherein:
a. The first coupling feature and the secondary coupling feature form a ball-and-socket relationship, the first coupling feature forming a rounded ball shape and the secondary coupling feature forming a receiving socket shape.

10. The pet toy of claim 1, wherein:
a. The first coupling feature and the secondary coupling feature form a sleeve-and-insert relationship, the first coupling feature forming a sleeve to receive the secondary coupling feature, the secondary coupling feature forming an insert shaped to be inserted into the first coupling feature sleeve.

11. The pet toy of claim 1, wherein:
a. The first coupling feature and the secondary coupling feature form a sleeve-and-insert relationship, the first coupling feature forming an insert to be inserted into the secondary coupling feature, the secondary coupling feature forming a sleeve to receive the first coupling feature.

12. The pet toy of claim 1, wherein:
a. The first segment exterior and the secondary segment exterior are textile materials.

13. A pet toy, comprising:
a. A first segment having a volume, the first segment having a plurality of first coupling features disposed on the exterior of the first segment.
b. A plurality of secondary segments each having a volume, the secondary segments each having a plurality of secondary coupling features disposed on the exterior of the secondary segment, the secondary coupling features configured to reversibly couple with the first coupling features.
c. A connecting element, the connecting element having a first end and a second end, the first end having a first end coupling feature and being reversibly coupled to the first segment, the second end having a second end coupling feature and being reversibly coupled to the secondary segment.

14. The pet toy of claim 13, wherein:
a. The first end of the connecting element is fixedly attached to the first segment, and the second end of the connecting element is fixedly attached to the secondary segment.

15. The pet toy of claim 13, wherein:
a. The attachment location of the first end to the first segment and the attachment location of the second end to the secondary segment are configured such that when the first segment is coupled to the secondary segment the first segment and secondary segment can envelope the connecting element.

16. The pet toy of claim 1, wherein:
a. The first segment exterior and the secondary segment exterior are textile materials.

17. A pet toy comprising:
a. A first main body having a volume; the main body having a plurality of cavities, the cavities each having a plurality of cavity openings, the cavities each having an interior cavity volume, the cavity openings being disposed on the secondary segment exterior,
b. A plurality of mini-toys each having a volume, the mini-toys being sized and shaped such that they can be inserted into the main body cavities.

18. The pet toy of claim 1, wherein:
a. The pet toy has one first segment and five secondary segments.

19. The pet toy of claim 1, wherein:
a. The pet toy has one first segment, four secondary segments, and one tertiary segment.
